(19) United States
(12) Patent Application Publication
(10) Pub. No.: US 2026/0225132 A1
(43) Pub. Date: Aug. 6, 2026

(54) ULTRASONIC SENSOR AND VEHICLE

(71) Applicant: Panasonic Automotive Systems Co., Ltd., Kanagawa (JP)

(72) Inventor: Takahiro SHIMA, Osaka (JP)

(73) Assignee: Panasonic Automotive Systems Co., Ltd., Kanagawa (JP)

(21) Appl. No.: 19/454,682

(22) Filed: Jan. 21, 2026

(30) Foreign Application Priority Data
Feb. 4, 2025 (JP) 2025-016719

(51) Int. Cl. B06B 1/02; B06B 1/06

(52) U.S. Cl. CPC B06B 1/0215; B06B 1/0648; B06B 2201/55

(57) ABSTRACT

An ultrasonic sensor according to the present disclosure includes: an ultrasonic transducer having a plurality of resonant frequencies; and a matching circuit that includes a plurality of LC parallel resonant circuits connected in series to each other, in which a resonant frequency of the plurality of LC parallel resonant circuits is less than a maximum value and greater than a minimum value of the plurality of resonant frequencies of the ultrasonic transducer.

### TECHNICAL FIELD

The present disclosure relates to an ultrasonic sensor that detects surrounding objects based on the reflected wave of a transmitted ultrasonic wave, and a vehicle.

### BACKGROUND ART

An ultrasonic sensor that transmits ultrasound and can detect an object by a reflected wave from a surrounding object has been widely used.

For example, Patent Literature (hereinafter, referred to as PTL) 1 discloses an ultrasonic sensor that switches a drive frequency to the same value as either of resonant frequency F0 and resonant frequency Fp to drive a ultrasonic transducer, where F0 is a resonant frequency of an equivalent series capacitor and an equivalent series inductor, and Fp is a resonant frequency determined by the equivalent parallel capacitor and an inductor connected in series between the ultrasonic transducer and a drive circuit.

PTL 2 discloses an ultrasonic sensor that can set a reverberation time of a output signal of a piezoelectric transducer within an appropriate range by sensing a reverberation time of an output of the piezoelectric transducer and performing on/off control of a plurality of switches according to the reverberation time.

### CITATION LIST

### Patent Literature

PTL 1
JP5195587
PTL 2
JP4192672

### SUMMARY OF INVENTION

An ultrasonic sensor according to an aspect of the present disclosure includes: an ultrasonic transducer having a plurality of resonant frequencies; and a matching circuit that includes a plurality of LC parallel resonant circuits connected in series to each other, in which a resonant frequency of the plurality of LC parallel resonant circuits is less than a maximum value and greater than a minimum value of the plurality of resonant frequencies of the ultrasonic transducer.

A vehicle according to an aspect of the present disclosure includes: the above-described ultrasonic sensor; and a detection circuit that detects an obstacle based on information related to each of a transmitted wave and a received wave acquired from the ultrasonic sensor.

### Advantageous Effects of Invention

According to the present disclosure, transmitting and receiving can be performed at a plurality of frequencies, and favorable characteristics can be obtained at each of the plurality of frequencies.

### BRIEF DESCRIPTION OF DRAWINGS

FIG. 1 is a schematic diagram illustrating a vehicle equipped with an ultrasonic sensor;

FIG. 2 is a graph illustrating frequency characteristics of the ultrasonic sensor according to each embodiment;

FIG. 3 is a diagram illustrating an example of a functional configuration including the ultrasonic sensor on the vehicle;

FIG. 4 is a diagram for describing an example of a configuration of the ultrasonic sensor according to the first embodiment;

FIG. 5 is a diagram for describing an example of a configuration of a matching circuit according to the first embodiment;

FIG. 6 is a cross-sectional schematic diagram illustrating an example of a structure of the ultrasonic transducer;

FIG. 7 is a diagram illustrating an equivalent circuit of the ultrasonic transducer;

FIG. 8 is a diagram for describing an example of a configuration of the ultrasonic sensor according to the second embodiment;

FIG. 9 is a diagram for describing an example of a configuration of the matching circuit according to the second embodiment;

FIG. 10 is a graph for describing effects obtained by the ultrasonic sensor according to the first embodiment and the ultrasonic sensor according to the second embodiment;

FIG. 11 is a diagram for describing a configuration of an ultrasonic sensor as a comparative example;

FIG. 12A is a graph illustrating frequency characteristics of the ultrasonic sensor of the comparative example,

FIG. 12B is a graph showing a reverberation time of the ultrasonic sensor of the comparative example;

FIG. 12C is a graph showing a reverberation time of the ultrasonic sensor of the comparative example;

FIG. 13A is a graph showing frequency characteristics of the ultrasonic sensor according to the first embodiment;

FIG. 13B is a graph showing a reverberation time of the ultrasonic sensor according to the first embodiment;

FIG. 13C is a graph showing a reverberation time of the ultrasonic sensor according to the first embodiment;

FIG. 14A is a graph showing frequency characteristics of the ultrasonic sensor according to the second embodiment;

FIG. 14B is a graph showing a reverberation time of the ultrasonic sensor according to the second embodiment; and

FIG. 14C is a graph showing a reverberation time of the ultrasonic sensor according to the second embodiment.

### DESCRIPTION OF EMBODIMENTS

Hereinafter, each embodiment of the present disclosure will be described in detail with reference to the drawings. However, unnecessarily detailed descriptions may be omitted, such as detailed descriptions of matters that are already well-known or redundant descriptions of substantially identical configurations.

### SUMMARY

In the following, each embodiment of the ultrasonic sensor according to the present disclosure will be described. The ultrasonic sensor according to the present disclosure can transmit ultrasound at a plurality of frequencies. In the following embodiments, an aspect in which the ultrasonic sensor can transmit ultrasound at two frequencies f₁ and f₂ will be described.

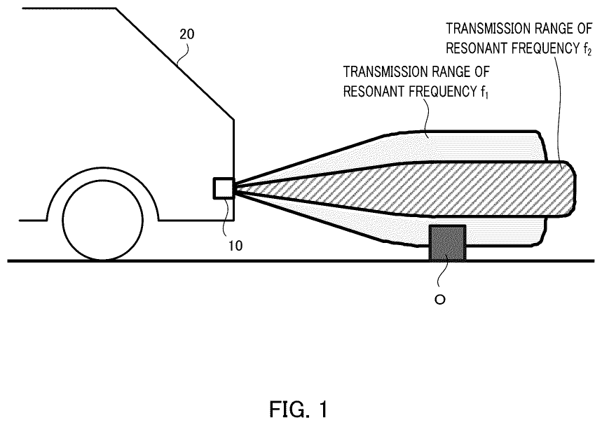

FIG. 1 is a schematic diagram illustrating vehicle 20 equipped with ultrasonic sensor 10. FIG. 1 illustrates an example in which ultrasonic sensor 10 configured to be mounted on a rear bumper of vehicle 20. In the example illustrated in FIG. 1, a vertical directivity (spread of a sound wave) at frequency f₁ is 35 degrees, and a vertical directivity at frequency f₂ is 16 degrees. Changing the vertical directivity depending on the transmission frequency in this way makes it easy to distinguish between an obstacle having a low height (for example, curb) such as an obstacle O illustrated in FIG. 1, and an obstacle that is not such an obstacle.

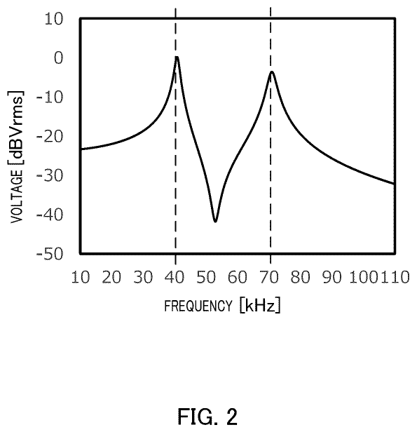

FIG. 2 is a graph showing frequency characteristics of ultrasonic sensor 10 according to each embodiment. The horizontal axis in FIG. 2 is frequency, and the vertical axis is voltage. In the example illustrated in FIG. 2, f₁ is set to 40 kHz, and f₂ is set to 70 kHz. In the present disclosure, the plurality of frequencies at which ultrasonic sensor 10 can transmit ultrasound are not limited to 40 kHz and 70 kHz, and can be set to any value by a designer of the ultrasonic sensor or the like.

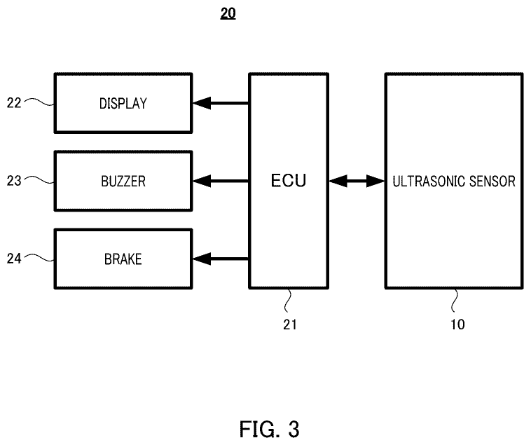

FIG. 3 is a diagram illustrating an example of a functional configuration including ultrasonic sensor 10 in vehicle 20. In the example illustrated in FIG. 3, vehicle 20 includes ultrasonic sensor 10, ECU 21, display 22, buzzer 23, and brake 24.

ECU (Engine Control Unit or Electronic Control Unit) 21 is a control unit that performs various controls in vehicle 20. ECU 21 operates as a detector that detects an obstacle around vehicle 20 based on at least information related to each of the transmitted wave and the received wave acquired from ultrasonic sensor 10. ECU 21 may perform traveling control of vehicle 20 and the like.

Display 22 is, for example, a display provided in the vehicle, and displays an obstacle or the like around vehicle 20 based on the control of ECU 21. Buzzer 23 is, for example, an audio alert device provided in the vehicle or outside the vehicle, and issues an alarm based on the control of ECU 21 when the distance between vehicle 20 and the obstacle is close. Brake 24 is a stop mechanism and a control mechanism of vehicle 20, and decelerates or stops vehicle 20 based on the control of ECU 21 when the distance between vehicle 20 and the obstacle is close.

In the following, ultrasonic sensor 10 will be described in detail in each of the first and second embodiments. Ultrasonic sensor 10 according to the first embodiment will be referred to as ultrasonic sensor 10A, and ultrasonic sensor 10 according to the second embodiment will be referred to as ultrasonic sensor 10B.

### First Embodiment

In the following, ultrasonic sensor 10A according to the first embodiment of the present disclosure will be described. Among the configurations described in the first embodiment, a configuration denoted with the letter A at the end of the reference numeral is a configuration unique to the first embodiment, and a configuration denoted without the letter A is a configuration having the same feature and property in the first embodiment and the second embodiment.

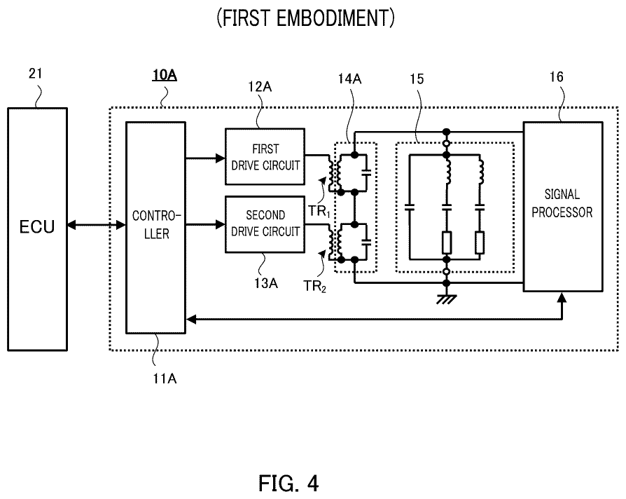

FIG. 4 is a diagram for describing an example of a configuration of ultrasonic sensor 10A according to the first embodiment. As illustrated in FIG. 4, ultrasonic sensor 10A includes controller 11A, first drive circuit 12A, second drive circuit 13A, matching circuit 14A, ultrasonic transducer 15, and signal processor 16. In the first embodiment, ultrasonic transducer 15 has two resonant frequencies f₁ and f₂, and ultrasonic sensor 10A can transmit ultrasound at either of two frequencies f₁ and f₂. However, it is assumed that f₁<f₂.

Controller 11A controls the operation of ultrasonic sensor 10A based on the control of ECU 21. Specifically, in a case where an instruction to transmit ultrasound at frequency f₁ is acquired from ECU 21, controller 11A outputs a pulse signal at frequency f₁ to first drive circuit 12A. In a case where an instruction to transmit ultrasound at frequency f₂ is acquired from ECU 21, controller 11A outputs a pulse signal at frequency f₂ to second drive circuit 13A.

First drive circuit 12A drives ultrasonic transducer 15 at frequency f₁ based on the pulse signal at frequency f₁ input from controller 11A. Second drive circuit 13A drives ultrasonic transducer 15 at frequency f₂ based on the pulse signal at frequency f₂ input from controller 11A. Ultrasonic sensor 10A according to the first embodiment includes two drive circuits, thereby enabling transmission of ultrasound at two frequencies at the same time.

Matching circuit 14A is a circuit that performs impedance matching between ultrasonic transducer 15 and other configurations of ultrasonic sensor 10A. For example, in the first embodiment, matching circuit 14A can improve output characteristics of the entire ultrasonic sensor 10A by canceling (bringing close to 0) the susceptance component of ultrasonic transducer 15 at two resonant frequencies f₁ and f₂ of ultrasonic transducer 15.

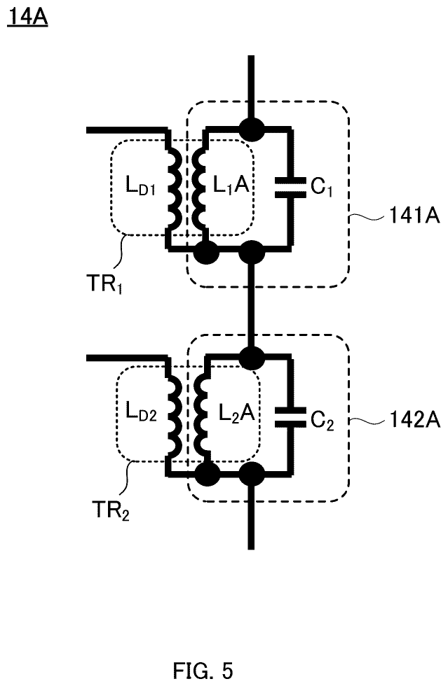

FIG. 5 is a diagram for describing an example of a configuration of matching circuit 14A according to the first embodiment. Matching circuit 14A includes two LC parallel resonant circuits 141A and 142A connected in series to each other. LC parallel resonant circuit 141A has a configuration in which parallel inductor L₁A and parallel capacitor C₁ are disposed in parallel to each other. LC parallel resonant circuit 142A has a configuration in which parallel inductor L₂A and parallel capacitor C₂ are disposed in parallel to each other.

As illustrated in FIGS. 4 and 5, parallel inductor L₁A of LC parallel resonant circuit 141A constitutes transformer TR₁ together with inductor LD₁ connected to first drive circuit 12A. Parallel inductor L₁A of LC parallel resonant circuit 141A constitutes a secondary side (output side) of transformer TR₁. In addition, as illustrated in FIGS. 4 and 5, parallel inductor L₂A of LC parallel resonant circuit 142A constitutes transformer TR₂ together with inductor LD₂ connected to second drive circuit 13A. Parallel inductor L₂A of LC parallel resonant circuit 142A constitutes a secondary side (output side) of transformer TR₂. Parallel inductor L₁A and parallel inductor L₂A are each an example of a first parallel inductor according to the present disclosure. Transformers TR₁ and TR₂ can easily convert the input voltage into a large voltage amplitude and have a high impedance when viewed from the secondary side to the primary side. The influence from the primary side is not transmitted to the secondary side, and transformers TR₁ and TR₂ can be used as input circuits to ultrasonic transducer 15.

Two LC parallel resonant circuits 141A and 142A are designed to have resonant frequency fₛ that is greater than the lower resonant frequency f₁ and less than the higher resonant frequency f₂ of two resonant frequencies f₁ and f₂ of ultrasonic transducer 15. This makes it possible to suitably cancel both the susceptance components at the two resonant frequencies f₁ and f₂ of ultrasonic transducer 15.

Where a capacitance of parallel capacitor C₁ is C₁, an inductance of parallel inductor L₁A is L₁, a capacitance of parallel capacitor C₂ is C₂, and an inductance of parallel inductor L₂A is L₂, resonant frequency fₛ of LC parallel resonant circuits 141A and 142A (resonant frequency of matching circuit 14A) can be expressed by the following Expression 1.

$${f}_{s} = \frac{1}{2 π} \sqrt{\frac{{L}_{1} + {L}_{2}}{{L}_{1} {L}_{2} ( {C}_{1} + {C}_{2} )}} \qquad ( Expression 1 )$$

The principle by which matching circuit 14A can suitably cancel both the susceptance components at the two resonant frequencies f₁ and f₂ of ultrasonic transducer 15 will be described later.

As described above, ultrasonic transducer 15 has two resonant frequencies f₁ and f₂. Ultrasonic transducer 15 transmits ultrasound at either of frequencies f₁ and f₂ based on the pulse signal input from first drive circuit 12A or second drive circuit 13A. Ultrasonic transducer 15 is, for example, an ultrasonic microphone.

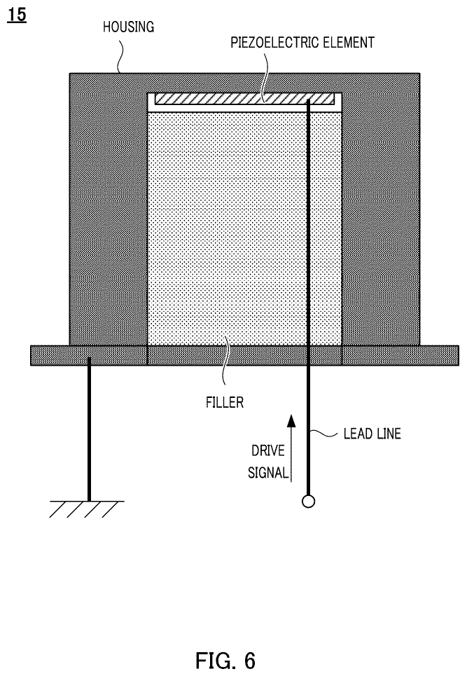

FIG. 6 is a cross-sectional schematic diagram illustrating an example of a structure of ultrasonic transducer 15. Ultrasonic transducer 15 is composed of a piezoelectric element attached to the inside of a tubular housing (aluminum or the like) and a filler. The piezoelectric element is connected to first drive circuit 12A, second drive circuit 13A, and signal processor 16 via a lead line. The housing is grounded.

Although not illustrated in FIG. 6, multiple frequency vibration modes can be provided with ultrasonic transducer 15 by providing a slit, a hole, a protrusion, or the like on the housing.

When a transmitted signal from the drive circuit is applied to the piezoelectric element via the lead line, compression strain or tensile strain occurs in the piezoelectric element, and the housing can be vibrated. Ultrasonic transducer 15 can transmit ultrasound.

When ultrasonic transducer 15 receives ultrasound, the piezoelectric element generates a received signal in response to the vibration of the housing. Signal processor 16 performs amplification processing, detection processing, or the like on the received signal, and controller 11A detects an obstacle around vehicle 20 based on the intensity of the received signal.

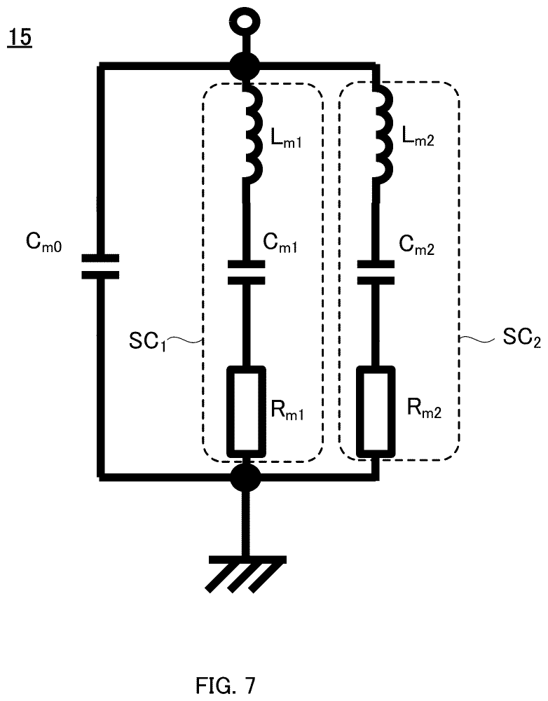

FIG. 7 is a diagram illustrating an equivalent circuit of ultrasonic transducer 15. In the example illustrated in FIG. 7, ultrasonic transducer 15 includes equivalent parallel capacitor Cₘ₀ and two RLC series circuits SC₁ and SC₂ connected in parallel to one another.

RLC series circuit SC₁ includes equivalent series inductor Lm₁, equivalent series capacitor Cm₁, and equivalent series resistor Rₘ₁. RLC series circuit SC₂ includes equivalent series inductor Lm₂, equivalent series capacitor Cm₂, and equivalent series resistor Rₘ₂.

Where an inductance of equivalent series inductor Lₘ₁ is Lₘ₁, a capacitance of equivalent series capacitor Cm₁ is Cm₁, an inductance of equivalent series inductor Lm₂ is Lm₂, and a capacitance of equivalent series capacitor Cm₂ is Cm₂, two resonant frequencies f₁ and f₂ of ultrasonic transducer 15 can be expressed by the following Expressions 2 and 3.

$${f}_{1} = \frac{1}{2 π \sqrt{{L}_{m 1} {C}_{m 1}}} \qquad ( Expression 2 )$$

$${f}_{2} = \frac{1}{2 π \sqrt{{L}_{m 2} {C}_{m 2}}} \qquad ( Expression 3 )$$

As described above, ultrasonic sensor 10A is designed such that a relationship of the following Expression 4 is established between RLC series circuits SC₁ and SC₂ and resonant frequency fₛ of matching circuit 14A (resonant frequency of LC parallel resonant circuits 141A and 142A).

$${f}_{1} < {f}_{s} < {f}_{2} \qquad ( Expression 4 )$$

Specifically, in designing ultrasonic sensor 10A, the inductors and the capacitances of parallel inductors L₁A and L₂A and parallel capacitors C₁ and C₂ included in matching circuit 14A and equivalent series inductors Lₘ₁ and Lm₂ and equivalent series capacitors Cₘ₁ and Cm₂ included in ultrasonic transducer 15 may be appropriately set to satisfy Expressions 1 to 4.

Configuring ultrasonic sensor 10A as described above enables matching circuit 14A to cancel the susceptance components at both of two resonant frequencies f₁ and f₂ of ultrasonic transducer 15, thereby improving the performance of ultrasonic sensor 10A. Specifically, the output increase of ultrasonic sensor 10A and the reduction of the reverberation time can be achieved at the same time.

### Second Embodiment

In the following, a second embodiment of the present disclosure will be described. Among the configurations described in the second embodiment, a configuration denoted with the letter B at the end of the reference numeral is a configuration unique to the second embodiment, and a configuration denoted without the letter B is a configuration having the same feature and property in the first embodiment and the second embodiment.

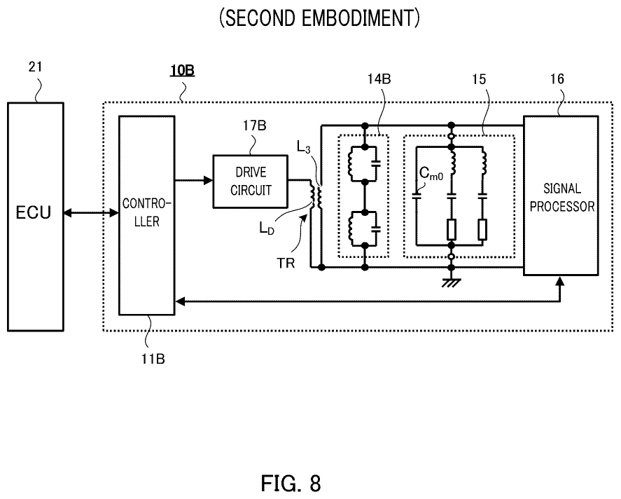

FIG. 8 is a diagram for describing an example of a configuration of ultrasonic sensor 10B according to the second embodiment. As illustrated in FIG. 8, ultrasonic sensor 10B includes controller 11B, matching circuit 14B, ultrasonic transducer 15, signal processor 16, and drive circuit 17B. In the second embodiment, as in the first embodiment, ultrasonic transducer 15 has two resonant frequencies f₁ and f₂, and ultrasonic sensor 10B can transmit ultrasound at either of two frequencies f₁ and f₂. However, it is assumed that f₁<f₂.

Controller 11B controls the operation of ultrasonic sensor 10B based on the control of ECU 21. Specifically, in a case where an instruction to transmit ultrasound at frequency f₁ is acquired from ECU 21, controller 11B outputs a pulse signal at frequency f₁ to drive circuit 17B. In a case where an instruction to transmit ultrasound at frequency f₂ is acquired from ECU 21, controller 11B outputs a pulse signal at frequency f₂ to drive circuit 17B.

In a case where the pulse signal at frequency f₁ is input from controller 11B, drive circuit 17B drives ultrasonic transducer 15 at frequency f₁. In a case where the pulse signal at frequency f₂ is input from controller 11B, drive circuit 17B drives ultrasonic transducer 15 at frequency f₂.

As described above, in ultrasonic sensor 10B according to the second embodiment, because the number of drive circuits is one, the structure can be simplified as compared with ultrasonic sensor 10A according to the first embodiment.

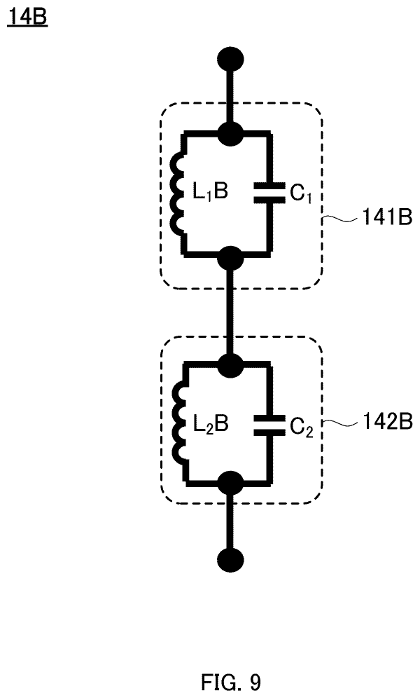

Matching circuit 14B is a circuit that performs impedance matching between ultrasonic transducer 15 and other configurations of ultrasonic sensor 10B. For example, matching circuit 14B of the second embodiment can improve the output characteristics of entire ultrasonic sensor 10B by canceling (bringing close to 0) the susceptance component of ultrasonic transducer 15 in the same manner as matching circuit 14A of the first embodiment. However, as illustrated in FIGS. 8 and 9, the circuit structure of matching circuit 14B in the second embodiment is different from the circuit structure of matching circuit 14A in the first embodiment.

FIG. 9 is a diagram for describing an example of a configuration of matching circuit 14B according to the second embodiment. Matching circuit 14B includes two LC parallel resonant circuits 141B and 142B connected in series to each other. LC parallel resonant circuit 141B has a configuration in which parallel inductor LIB and parallel capacitor C₁ are disposed in parallel to each other. LC parallel resonant circuit 142B has a configuration in which parallel inductor L₂B and parallel capacitor C₂ are disposed in parallel to each other.

As in the first embodiment, two LC parallel resonant circuits 141B and 142B are designed to have resonant frequency fₛ that is greater than f₁ and less than f₂ of two resonant frequencies f₁ and f₂ of ultrasonic transducer 15. This makes it possible to suitably cancel both the susceptance components at the two resonant frequencies f₁ and f₂ of ultrasonic transducer 15.

Where a capacitance of parallel capacitor C₁ is C₁, an inductance of parallel inductor L₁B is L₁, a capacitance of parallel capacitor C₂ is C₂, and an inductance of parallel inductor L₂B is L₂, resonant frequency fₛ of LC parallel resonant circuits 141B and 142B (resonant frequency of matching circuit 14B) can be expressed by the above Expression 1.

In ultrasonic sensor 10B in the second embodiment, the inductors and the capacitances of parallel inductors LIB and L₂B and parallel capacitors C₁ and C₂ included in matching circuit 14B and equivalent series inductors Lₘ₁ and Lm₂ and equivalent series capacitors Cm₁ and Cm₂ included in ultrasonic transducer 15 are appropriately set to satisfy Expressions 1 to 4 described in the first embodiment. Configuring ultrasonic sensor 10B as described above enables matching circuit 14B to cancel the susceptance components at both of two resonant frequencies f₁ and f₂ of ultrasonic transducer 15, thereby improving the performance of ultrasonic sensor 10B. Specifically, the output increase of ultrasonic sensor 10B and the reduction of the reverberation time can be achieved at the same time.

In ultrasonic sensor 10B according to the second embodiment, unlike ultrasonic sensor 10A according to the first embodiment, parallel inductors LIB and L₂B of matching circuit 14B do not constitute transformers.

As illustrated in FIG. 8, in ultrasonic sensor 10B according to the second embodiment, parallel inductor L₃ disposed in parallel to matching circuit 14B and ultrasonic transducer 15 is provided. Parallel inductor L₃ is an example of a second parallel inductor according to the present disclosure.

Parallel inductor L₃ constitutes transformer TR connected to drive circuit 17B together with inductor LD connected to drive circuit 17B.

Resonant frequency fₐ of parallel inductor L₃ and equivalent parallel capacitor Cₘ₀ included in ultrasonic transducer 15 is designed to satisfy the following Expression 5.

$${f}_{1} < {f}_{a} < {f}_{2} \qquad ( Expression 5 )$$

The susceptance component of ultrasonic transducer 15 becomes 0 near resonant frequency fₐ, and thus setting resonant frequency fₐ to a value satisfying Expression 5 reduces the susceptance components of ultrasonic transducer 15 at resonant frequencies f₁ and f₂, thereby more easily canceling the susceptance components.

### Principle

In the following, specific effects of ultrasonic sensor 10A according to the first embodiment and ultrasonic sensor 10B according to the second embodiment described above, and a principle of the effects will be described.

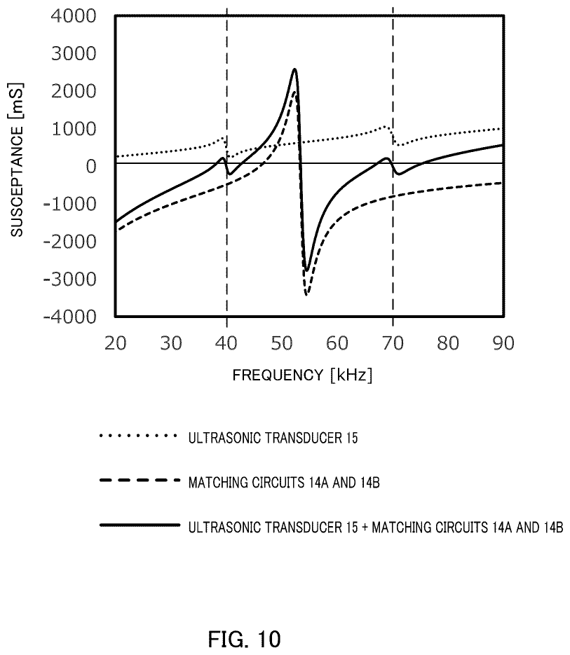

FIG. 10 is a graph for describing the effects obtained by ultrasonic sensor 10A according to the first embodiment and ultrasonic sensor 10B according to the second embodiment, and the principle thereof.

FIG. 10 illustrates a relationship between frequency and the susceptance components in a case where ultrasonic sensors 10A and 10B can transmit ultrasound at two frequencies of 40 kHz and 70 kHz. In FIG. 10, a dotted line indicates the susceptance component of ultrasonic transducer 15, a broken line indicates the susceptance component of matching circuits 14A and 14B, and a solid line indicates the component obtained by adding the susceptance component of ultrasonic transducer 15 and the susceptance component of matching circuits 14A and 14B.

In the existing configuration of an ultrasonic sensor, it is empirically known that when there is no resonance frequency, the waveform generally shows that the susceptance component increases as the frequency increases. On the other hand, as illustrated in FIG. 10, the susceptance component is significantly reduced near the resonant frequency.

As described above, ultrasonic transducer 15 has two resonant frequencies of 40 kHz and 70 kHz. The susceptance components at the resonant frequencies have values that are not 0. In the example illustrated in FIG. 10, the susceptance component at 40 kHz is less than the susceptance component at 70 kHz. In the example illustrated in FIG. 10, the susceptance component of ultrasonic transducer 15 at 40 kHz is 488 μS, and the susceptance component of ultrasonic transducer 15 at 70 kHz is 805 μS.

As described in the first and second embodiments, matching circuits 14A and 14B are designed such that the resonant frequency thereof is greater than the smaller value and less than the large value of the two resonant frequencies of ultrasonic transducer 15. In the example illustrated in FIG. 10, the resonant frequencies of matching circuits 14A and 14B are designed to be 53.5 kHz. Thus, the susceptance components of matching circuits 14A and 14B at 40 kHz are −489 μS, and the susceptance components of matching circuits 14A and 14B at 70 kHz are −806 μS.

As described above, in the existing configuration of the ultrasonic sensor, except at the resonance frequency, the waveform generally shows that the susceptance component increases as the frequency increases. However, by designing matching circuits 14A and 14B such that the resonant frequency thereof is greater than the minimum value and less than the maximum value of the two resonant frequencies of ultrasonic transducer 15, the susceptance components of matching circuits 14A and 14B at the minimum value of the resonant frequencies of ultrasonic transducer 15 can be set to values greater than the susceptance components of matching circuits 14A and 14B at the maximum value of the resonant frequencies of ultrasonic transducer 15.

By designing matching circuits 14A and 14B in this manner, the susceptance components of matching circuits 14A and 14B at each of 40 kHz and 70 kHz can be set to values at which the susceptance component of ultrasonic transducer 15 at each of 40 kHz and 70 kHz can be canceled.

Consequently, as indicated by the solid line in FIG. 10, the susceptance components of ultrasonic transducer 15 can be suitably canceled by the susceptance components of matching circuits 14A and 14B at both of the two resonant frequencies of 40 kHz and 70 kHz of ultrasonic transducer 15. Accordingly, the output increase of ultrasonic sensors 10A and 10B and the reduction of the reverberation time can be achieved at the same time.

In FIG. 10, an example has been shown in which the susceptance component of ultrasonic transducer 15 is canceled by the susceptance components of matching circuits 14A and 14B at both of the two resonant frequencies of 40 kHz and 70 kHz to bring the susceptance component of ultrasonic transducer 15 approximately 0 at each resonant frequency. The example illustrated in FIG. 10 is the most suitable example of the present disclosure, and the present disclosure is not limited to a case of bring the susceptance component of the ultrasonic transducer approximately 0 by the susceptance component of the matching circuit at all of the plurality of resonant frequencies at which the ultrasonic sensor can transmit ultrasound.

As described above, by setting the resonant frequency of the matching circuit to a value greater than the minimum value fₘᵢₙ and less than the maximum value fₘₐₓ of the plurality of resonant frequencies of the ultrasonic transducer, the susceptance component of the matching circuit at the minimum value fₘᵢₙ can be set to a value greater than the susceptance component of the matching circuit at the maximum value fₘₐₓ. Because the susceptance component of the ultrasonic transducer at the minimum value fₘᵢₙ is less than the susceptance component of the ultrasonic transducer at the maximum value fₘₐₓ, the susceptance component of the ultrasonic transducer can be brought close to 0 by the susceptance component of the matching circuit at both of the minimum value fₘᵢₙ and the maximum value fₘₐₓ by such a matching circuit.

### EXAMPLES

In the following, examples of the first embodiment and the second embodiment will be described in comparison with a comparative example.

### Frequency Characteristics and Reverberation Time of Comparative Example

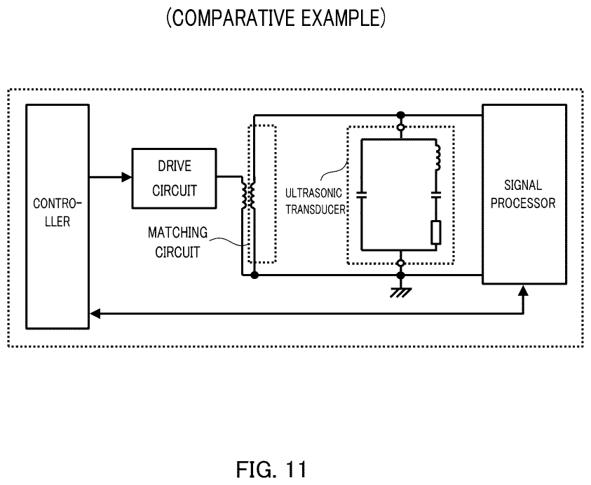

As a comparative example, an ultrasonic sensor having a circuit configuration illustrated in FIG. 11 is assumed. FIG. 11 is a diagram illustrating a configuration of an ultrasonic sensor as a comparative example. As illustrated in FIG. 11, in the ultrasonic sensor as the comparative example, the ultrasonic transducer does not include a plurality of RLC series circuits, and the matching circuit does not include a plurality of parallel resonant circuits. In the ultrasonic sensor as the comparative example, the drive circuit is configured to transmit ultrasound at a plurality of frequencies by driving the ultrasonic transducer at different drive frequencies.

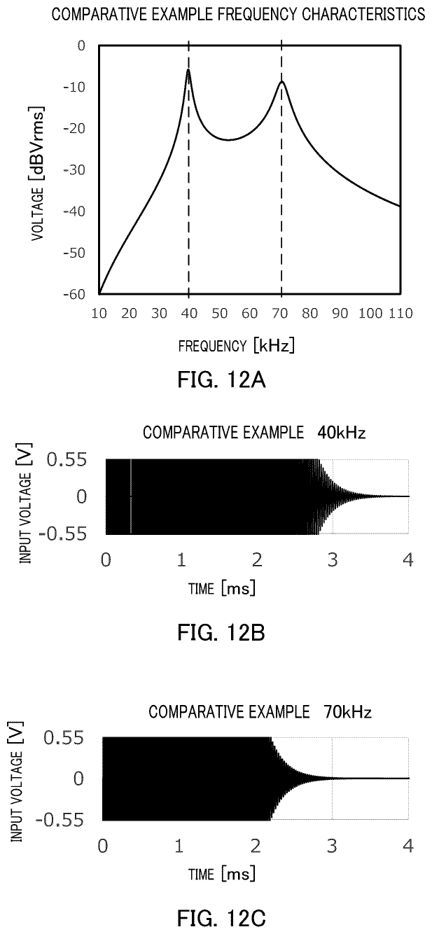

FIGS. 12A to 12C are graphs showing frequency characteristics and reverberation times of the ultrasonic sensor of the comparative example. FIGS. 12A to 12C are created by simulation.

FIG. 12A illustrates frequency characteristics of the ultrasonic sensor of the comparative example during receiving. As illustrated in FIG. 12A, the ultrasonic sensor of the comparative example can transmit ultrasound at two frequencies of 40 kHz and 70 kHz. An output at 40 kHz is −6.7 dB, and an output at 70 kHz is −9.2 dB.

FIG. 12B illustrates a reverberation time of the ultrasonic sensor of the comparative example at 40 kHz. As illustrated in FIG. 12B, the reverberation time of the ultrasonic sensor of the comparative example at 40 kHz is 2.81 ms.

FIG. 12C illustrates a reverberation time of the ultrasonic sensor of the comparative example at 70 kHz. As illustrated in FIG. 12C, the reverberation time of the ultrasonic sensor of the comparative example at 70 kHz is 2.20 ms.

### Frequency Characteristics and Reverberation Time of Ultrasonic Sensor 10A According to First Embodiment

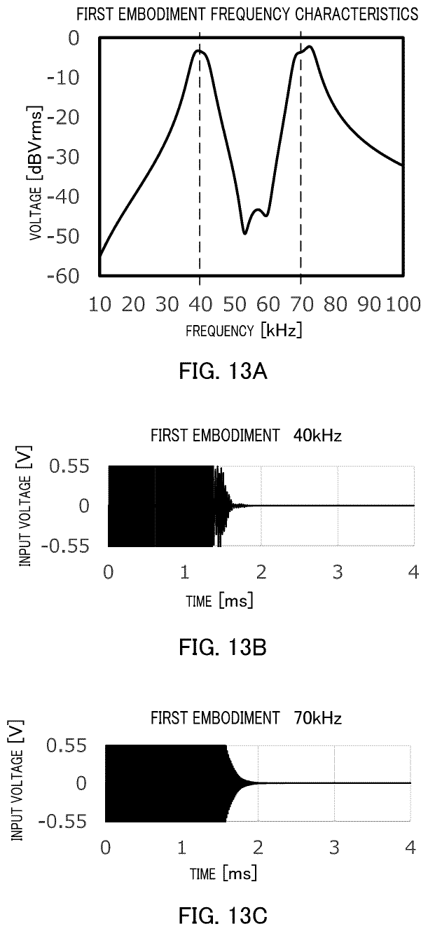

FIGS. 13A to 13C are graphs showing frequency characteristics and reverberation times of ultrasonic sensor 10A according to the first embodiment. FIGS. 13A to 13C are created by simulation.

FIG. 13A illustrates frequency characteristics of ultrasonic sensor 10A according to the first embodiment during receiving. In ultrasonic sensor 10A according to the first embodiment, an output at 40 kHz is −3.5 dB, and an output at 70 kHz is −3.5 dB. Thus, in ultrasonic sensor 10A according to the first embodiment, large outputs can be obtained as compared with the ultrasonic sensor of the comparative example.

FIG. 13B illustrates a reverberation time of the ultrasonic sensor according to the first embodiment at 40 kHz. As illustrated in FIG. 13B, the reverberation time of the ultrasonic sensor according to the first embodiment at 40 kHz is 1.47 ms.

FIG. 13C illustrates a reverberation time of the ultrasonic sensor according to the first embodiment at 70 kHz. As illustrated in FIG. 13C, the reverberation time of the ultrasonic sensor according to the first embodiment at 70 kHz is 1.57 ms.

Therefore, in ultrasonic sensor 10A according to the first embodiment, the reverberation time can be further reduced as compared with the ultrasonic sensor of the comparative example.

### Frequency Characteristics and Reverberation Time in Ultrasonic Sensor 10B According to Second Embodiment

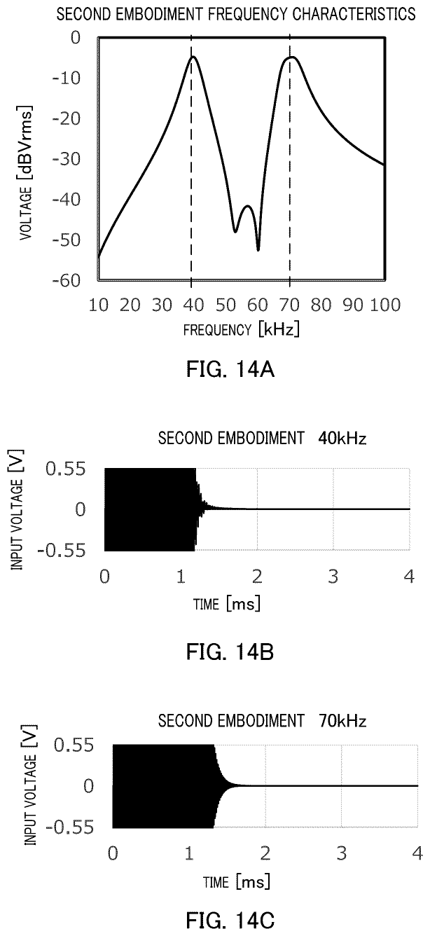

FIGS. 14A to 14C are graphs showing frequency characteristics and reverberation times of ultrasonic sensor 10B according to the second embodiment. FIGS. 14A to 14C are created by simulation.

FIG. 14A illustrates frequency characteristics of ultrasonic sensor 10B according to the second embodiment during receiving. In ultrasonic sensor 10B according to the second embodiment, an output at 40 kHz is −4.8 dB, and an output at 70 kHz is −5.0 dB. Thus, in ultrasonic sensor 10B according to the second embodiment, large outputs can be obtained as compared with the ultrasonic sensor of the comparative example.

FIG. 14B illustrates a reverberation time of the ultrasonic sensor according to the second embodiment at 40 kHz. As illustrated in FIG. 14B, the reverberation time of the ultrasonic sensor according to the second embodiment at 40 kHz is 1.19 ms.

FIG. 14C illustrates a reverberation time of the ultrasonic sensor according to the second embodiment at 70 kHz. As illustrated in FIG. 14C, the reverberation time of the ultrasonic sensor according to the second embodiment at 70 kHz is 1.32 ms.

Therefore, in ultrasonic sensor 10B according to the second embodiment, the reverberation time can be further reduced as compared with the ultrasonic sensor of the comparative example.

As described in the above examples, it can be seen that, in ultrasonic sensors 10A and 10B according to the first and second embodiments of the present disclosure, favorable characteristics can be obtained as compared with the comparative example in which the matching circuit does not include a plurality of parallel resonant circuits.

### Variation

The embodiments described above are merely examples of preferred aspects of the present disclosure, and the present disclosure is not limited to these embodiments and various modifications can be adopted.

In each of the embodiments described above, ultrasonic transducer 15 has two resonant frequencies f₁ and f₂, and matching circuits 14A and 14B are designed such that the resonant frequency fₛ satisfies f₁<fₛ<f₂. In the present disclosure, the number of resonant frequencies of the ultrasonic transducer is not limited to two and may be three or more.

In this case, the resonant frequency of the matching circuit may be designed to have a value greater than the minimum value and less than the maximum value of the plurality of resonant frequencies of the ultrasonic transducer. With such an aspect, the performance of the ultrasonic sensor can be also suitably improved as in the above-described examples.

The expressions “ . . . processor”, “ . . . -er”, “ . . . -or”, and “ . . . -ar” in each embodiment described above may be replaced with other expressions such as “ . . . circuitry”, “assembly”, “ . . . device”, “ . . . unit”, or “ . . . module”.

While various embodiments have been described herein above, it is to be appreciated that various changes in form and detail may be made without departing from the spirit and scope of the disclosure(s) presently or hereafter claimed.

This application is entitled to and claims the benefit of Japanese Patent Application No. 2025-016719, filed on Feb. 4, 2025, the disclosure of which including the specification, drawings and abstract is incorporated herein by reference in its entirety.

### INDUSTRIAL APPLICABILITY

The present disclosure is useful for an ultrasonic sensor that detects an object by transmitting and receiving ultrasound.

1. An ultrasonic sensor, comprising:
an ultrasonic transducer having a plurality of resonant frequencies; and
a matching circuit which, in operation, includes a plurality of LC parallel resonant circuits connected in series to each other, wherein a resonant frequency of the plurality of LC parallel resonant circuits is less than a maximum value and greater than a minimum value of the plurality of resonant frequencies of the ultrasonic transducer.

2. The ultrasonic sensor according to claim 1, further comprising:
a drive circuit which, in operation, drives the ultrasonic transducer; and
a transformer which, in operation, is connected to the drive circuit, wherein
a secondary side of the transformer is constituted by a first parallel inductor included in the LC parallel resonant circuit.

3. The ultrasonic sensor according to claim 2, further comprising:
a plurality of the drive circuits equal in number to the plurality of resonant frequencies of the ultrasonic transducer.

4. The ultrasonic sensor according to claim 3, wherein
each of the plurality of drive circuits which, in operation, drives the ultrasonic transducer at any one of the plurality of resonant frequencies.

5. The ultrasonic sensor according to claim 1, further comprising:
a drive circuit which, in operation, drives the ultrasonic transducer; and
a transformer which, in operation, is connected to the drive circuit, wherein a secondary side of the transformer is constituted by a second parallel inductor disposed in parallel to the plurality of LC parallel resonant circuits.

6. The ultrasonic sensor according to claim 5, wherein
the drive circuit which, in operation, drives the ultrasonic transducer at a frequency equal to any one of the plurality of resonant frequencies.

7. The ultrasonic sensor according to claim 5, wherein
a resonant frequency of an equivalent parallel capacitor included in the ultrasonic transducer and the second parallel inductor is less than the maximum value and greater than the minimum value of the plurality of resonant frequencies of the ultrasonic transducer.

8. A vehicle, comprising:
the ultrasonic sensor according to claim 1; and
a detection circuit which, in operation, detects an obstacle based on information related to each of a transmitted wave and a received wave acquired from the ultrasonic sensor.
